(19) United States
(12) Patent Application Publication
(10) Pub. No.: US 2022/0245531 A1
(43) Pub. Date: Aug. 4, 2022

(54) SEARCH SYSTEM AND SEARCH METHOD THEREOF AT AN AGREED MEETING PLACE

(71) Applicant: SHIH PI TA TECHNOLOGY LTD., Taipei City (TW)

(72) Inventor: Jen-Chang WU, TAIPEI CITY (TW)

(21) Appl. No.: 17/586,736

(22) Filed: Jan. 27, 2022

(30) Foreign Application Priority Data
Jan. 29, 2021 (TW) 110103548

(51) Int. Cl. G06Q 10/02; B60Q 1/50; B60Q 5/00; H04W 4/02; G06Q 50/30

(52) U.S. Cl. CPC G06Q 10/02; B60Q 1/50; G06Q 50/30; H04W 4/025; B60Q 5/005

(57) ABSTRACT

A search system is used for providing a passenger and a dispatched taxi driver to confirm each other. The system includes a server terminal, a passenger terminal for sending a driver search request signal to the server terminal, and a driver terminal device for sending a passenger search request signal to the server terminal. When the server terminal receives the driver search request signal form the passenger terminal device, the server terminal generates a driver terminal control signal to control the driver terminal device to generate a first response signal to respond to the passenger.

### CROSS-REFERENCE TO RELATED APPLICATION

This application claims priority to Taiwan Application Serial Number 110103548, filed on Jan. 29, 2021, which is herein incorporated by reference.

### BACKGROUND

### Technical Field

The present invention relates to a search system and method, and more particularly relates to a search method and apparatus thereof for providing a dispatching taxi driver and passengers to search for each other at an agreed meeting place.

### Description of Related Art

By disposing the vehicle information system in a taxi, passengers can call a taxi service through the Internet and telephone, which improves the convenience for passengers. Moreover, the vehicle company also may dispatch a taxi for passengers through the vehicle information system in a taxi, which may decrease the vacancy rate and increase the substantial revenue. However, when the dispatched taxi or the passenger arrives at the agreed meeting place, a lot of taxis and passengers also appear at the agreed meeting place at the same time, which causes the dispatched taxi or the passenger to take the wrong car or carry the wrong passenger. Therefore, how to prevent this case from happening is the goal of pursuit.

### SUMMARY

An aspect of present disclosure provides a search system used for providing a passenger and a dispatched taxi driver to confirm each other at an agreed meeting place, comprising: a server terminal; a passenger terminal device wirelessly connected to the server terminal for sending a driver search request signal to the server terminal at the agreed meeting place; and a driver terminal device wirelessly connected to the server terminal, wherein when the server terminal receives the driver search request signal form the passenger terminal device, the server terminal generates a driver terminal control signal to control the driver terminal device to generate a first response signal to respond to the passenger.

In an embodiment, the server terminal further comprising a database device storing a plurality of pairing data, wherein each of the pairing data includes an agreed meeting place, a passenger data, and a paired driver data; a receiving device for receiving the driver search request signal; a processing element coupled to the receiving device for generating the driver terminal control signal according to the driver search request signal; and a transmitting device coupled to the processing device for transmitting the driver terminal control signal, wherein the processing device searches for a corresponding driver terminal device from the database device according to the driver search request signal to control the transmitting device to send the driver terminal control signal to the corresponding driver terminal device.

In an embodiment, to control the driver terminal device to generate the first response signal is that the driver terminal control signal controls a vehicle light of the dispatched taxi to flash or a horn of the dispatched taxi to generate sound for the passenger to recognize through the driver terminal device.

In an embodiment, the vehicle light is front lights of the dispatched taxi, rear lights of the dispatched taxi, the roof lights of the dispatched taxi, or a LED light disposed in the dispatched taxi.

In an embodiment, the horn plays a recognition sound for the passenger to recognize.

In an embodiment, the driver terminal device is a handheld device of the dispatched taxi driver or a vehicle information system on the dispatched taxi.

In an embodiment, an application program sent by the server terminal is installed on the driver terminal device to communicate with the server terminal through the application program.

Another aspect of present disclosure provides a search system used for providing a passenger and a dispatched taxi driver to confirm each other at an agreed meeting place, comprising a server terminal; a passenger terminal device wirelessly connected to the server terminal; and a driver terminal device wirelessly connected to the server terminal for sending a passenger search request signal to the server terminal at the agreed meeting place, wherein when the server terminal receives the passenger search request signal form the driver terminal device, the server terminal generates a passenger terminal control signal to control the passenger terminal device to generate a first response signal to respond to the dispatched taxi driver.

In an embodiment, the server terminal further comprising a database device storing a plurality of pairing data, wherein each of the pairing data includes an agreed meeting place, a passenger data, and a paired driver data; a receiving device for receiving the driver search request signal; a processing element coupled to the receiving device for generating the driver terminal control signal according to the driver search request signal; and a transmitting device coupled to the processing device for transmitting the driver terminal control signal, wherein the processing device searches for a corresponding passenger terminal device from the database device according to the passenger search request signal to control the transmitting device to send the passenger terminal control signal to the corresponding passenger terminal device.

In an embodiment, to control the passenger terminal device to generate the first response signal is that the passenger terminal control signal controls the passenger terminal device to vibrate, to flash or to play a recognition sound for the dispatched taxi driver to recognize.

In an embodiment, the passenger terminal device is a handheld device of the passenger.

In an embodiment, an application program sent by the server terminal is installed on the passenger terminal device to communicate with the server terminal through the application program.

In an embodiment, while the driver terminal device sending the passenger search request signal to the server terminal, the driver terminal device controls a vehicle light of the dispatched taxi to flash or a horn of the dispatched taxi to generate sound for the passenger to recognize.

In an embodiment, the vehicle light is front lights of the dispatched taxi, rear lights of the dispatched taxi, the roof lights of the dispatched taxi, or a LED light disposed in the dispatched taxi.

In an embodiment, the horn plays a recognition sound for the passenger to recognize.

Still another aspect of present disclosure provides a search method used for providing a passenger to confirm a dispatched taxi driver in an agreed meeting place, comprising issuing, by a passenger terminal device, a driver search request signal to a server terminal at the agreed meeting place; generating, by a processing device of the server terminal, a driver terminal control signal to a driver terminal device according to the driver search request signal; and generating, by the driver terminal device, a first response signal to respond to the passenger.

Still another aspect of present disclosure provides a search method used for providing a dispatched taxi driver to confirm a passenger in an agreed meeting place, comprising issuing, by a driver terminal device, a passenger search request signal to a server terminal; generating, by a processing device of the server terminal, a passenger terminal control signal to a passenger terminal device according to the passenger search request signal; and generating, by the passenger terminal device, a first response signal to respond to the dispatched taxi driver.

Accordingly, the server terminal can control the passenger terminal device or/and the driver terminal device to vibrations, flashes or generate sound for the taxi driver or the passenger to recognize. Therefore, the driver and passengers can confirm for each other faster. The present application can solve the problem that the driver and passengers are difficult to confirm when they arrive at the agreed meeting place because there are too many similar appearance taxis at the agreed meeting place at the same time.

It is noted that the description above and the embodiments in the following paragraphs are merely examples for explaining the contents of the claims of the present disclosure.

### BRIEF DESCRIPTION OF THE DRAWINGS

The present disclosure can be more fully understood by reading the following detailed description of the embodiments, with reference made to the accompanying drawings as follows:

FIG. 1 is a schematic diagram of a search system according to an embodiment of the present disclosure.

FIG. 2 is a schematic diagram of a server terminal according to an embodiment of the present disclosure.

FIG. 3 is a flow chart of a taxi driver searching passengers according to an embodiment of the present disclosure.

FIG. 4 is a flow chart of passengers searching a taxi drive according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

As used herein, the terms “comprising,” “including,” “having,” and the like are to be understood to be open-ended, i.e., to mean including but not limited to.

As used herein, the term “and/or” includes any and all combinations of one or more of the associated listed items.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

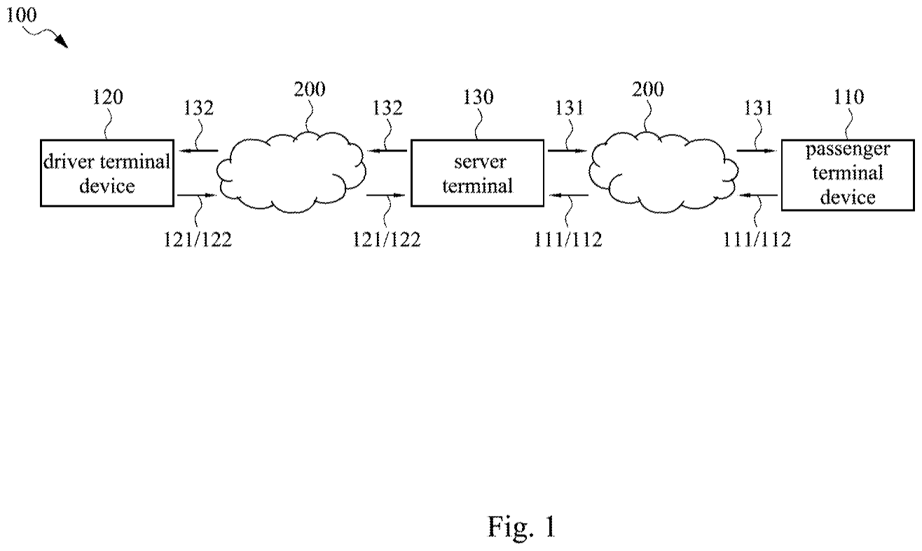

FIG. 1 is a schematic diagram of a search system according to an embodiment of the present disclosure. The search system 100 is used to provide a dispatched taxi driver and a passenger to search for each other in an agreed meeting place. The search system 100 includes a passenger terminal device 110, a driver terminal device 120, and a server terminal 130.

The passenger terminal device 110 is connected to the server terminal 130 via the network 200. The passenger terminal device 110 is used to transmit a driver search request signal 111 to the server terminal 130 or receive a passenger terminal control signal 131 from the server terminal 130. In one embodiment, the passenger terminal device 110 may be a mobile device, such as a mobile phone. However, the present invention is not limited to this. In another embodiment, the passenger terminal device 110 is a tablet computer, a personal digital assistant (PDA) and so on. According to an embodiment of the present invention, the server terminal 130 may provide an application program (APP) installed on the passenger terminal device 110 as a communication medium between the passenger terminal device 110 and the server terminal 130. In an embodiment, the driver search request signal 111 comprises the passenger's identity. In an embodiment, the passenger's identity can be the passenger's telephone number. In one embodiment, the passenger terminal control signal 131 is a passenger terminal control signal for controlling the passenger terminal device 110 to vibrate or flash, or to play a recognition sound for the dispatched taxi driver to recognize. In another embodiment, while the passenger terminal device 110 transmits the driver search request signal 111 to the server terminal 130, the passenger terminal device 110 may also be triggered to emit a vibration or flashing light, or to play a recognition sound for the driver to recognize.

The driver terminal device 120 can be connected to the server terminal 130 via the network 200. The driver terminal device 120 is used to transmit a passenger search request signal 121 to the server terminal 130 or receive a driver terminal control signal 132 from the server terminal 130. In one embodiment, the driver terminal device 120 may be a vehicle information system installed on a taxi. However, the present invention is not limited to this. In other embodiment, the driver terminal device 120 may also be a handheld device of a taxi driver, such as the driver's mobile phone. In an embodiment, an application program (APP) provided by the server terminal 130 is installed in the driver's mobile phone to serve as a communication medium between the driver's mobile phone and the server terminal 130. In an embodiment, the passenger search request signal 121 may comprises vehicle information. In an embodiment, the vehicle information includes unique identification data, such as the driver's name, the contact information, the taxi license plate number, and the taxi driver's license number. The passengers may verify the driver's identity after passengers to board the vehicle. In one embodiment, the driver terminal control signal 132 is a driver terminal control signal used to control the driver terminal device 120 to vibrate or flash, or to play a recognition sound for passengers to recognize. In another embodiment, while the driver terminal device 120 sends the passenger search request signal 121 to the server terminal 130, the driver terminal device 120 can also is triggered to control the taxi to vibrate or flash, or to play a recognition sound for passengers to recognize. In an embodiment, the front lights, the rear lights, or the roof lights of the taxi can be used to flash, or an LED light additionally installed on the taxi can be used to flash. A taxi horn or an additional buzzer installed on the taxi is used to play a recognition sound for passengers to recognize. The recognition sound can be a fixed music or a music designated by the passengers.

The server terminal 130 is a remote cloud server for receiving the passenger search request signal 121 sent by the driver terminal device 120 through the network 200 to generate a passenger terminal control signal 131 to control the passenger terminal device 110 to vibrate or flash light or to play a recognition sound for the dispatched taxi driver to recognize. The server terminal 130 also receives the driver search request signal 111 transmitted by the passenger terminal device 110 through the network 200 to generate a driver terminal control signal 132 to control the driver terminal device 120 to vibrate or flash, or to play a recognition sound for the passengers to recognize. By this way, the driver terminal device 120 and the passenger terminal device 110 can search the corresponding passenger or taxi driver through the server terminal 130.

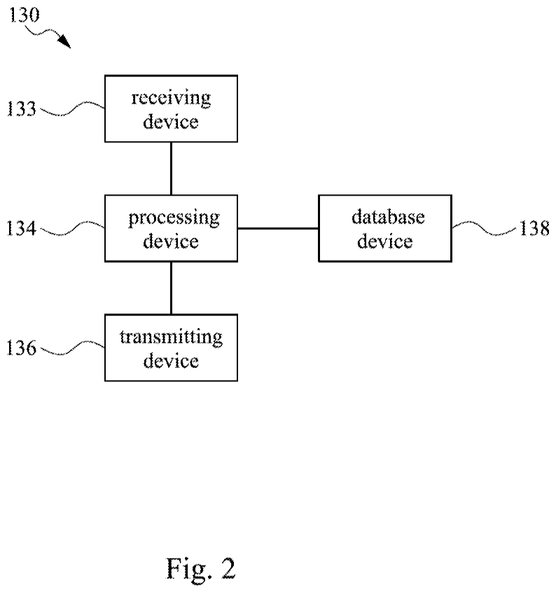

FIG. 2 is a schematic diagram of a server terminal according to an embodiment of the present disclosure. The server terminal 130 of the present invention includes a receiving device 133, a processing device 134, a transmitting device 136, and a database device 138. In one embodiment, each of the above-mentioned may be configured as a hardware device, software program, firmware, or a combination thereof. In another embodiment, each of the above-mentioned devices can also be configured by circuit loops or other appropriate types, and each of the above-mentioned devices can be configured in a separate type, or in a combined type.

The receiving device 133 is used for receiving the passenger search request signal 121 transmitted by the driver terminal device 120 and the driver search request signal 111 transmitted by the passenger terminal device 110. In one embodiment, the passenger search request signal 121 is generated by the driver touching or pressing the input module of the driver terminal device 120, and the driver search request signal 111 is generated by the passenger touching or pressing the input module of the passenger terminal device 110. The passenger search request signal 121 is transmitted to the receiving device 133 of the server terminal 130 through the communication devices of the driver terminal device 120. The driver search request signal 111 is transmitted to the receiving device 133 of the server terminal 130 through the communication devices of the passenger terminal device 110. In one embodiment, the input module is a physical button or touch screen of the driver terminal device 120 and the passenger terminal device 110. If the input module is a touch screen, the application program (APP) provided by the server terminal 130 can display a search request signal icon on the touch screens of the driver terminal device 120 and the passenger device 110. The driver and the passenger may send out the passenger search request signal 121 and the driver search request signal 111, respectively, by touching the search request signal icon. In one embodiment, the passenger search request signal 121 sent by the driver terminal device 120 includes the driver's contact information, such as the communication number of the driver terminal device 120. On the other hand, the driver search request signal 111 sent by the passenger terminal device 110 includes the passenger contact information, such as the communication number of the passenger terminal device 110.

The database device 138 stores a plurality of pairing data. In one embodiment, when the passenger terminal device 110 requests a taxi through a mobile phone or an application program (APP) provided by the server terminal 130, each passenger device 110 sends the agreed meeting place and passenger information to the server terminal 130. The processing device 134 of the server terminal 130 will perform the corresponding taxi pairing process according to the agreed meeting place of the passenger's request, and store the matching result in the database device 138. Therefore, the database device 138 will store a plurality of pairing data. Each of the pairing data includes the agreed meeting place, passenger data and the matched driver data. The passenger data is the communication number of the passenger device 110, and the driver data is the communication number of the driver terminal device 120. Accordingly, when the taxi driver or passenger arrives at the agreed meeting place, the driver can send a passenger search request signal 121 to the receiving device 133 of the server terminal 130 through the driver terminal device 120, and the passenger can also send a driver search request signal 111 to the receiving device 133 of the server terminal 130 through the passenger terminal device 110. When the receiving device 133 receives the passenger search request signal 121 or the driver search request signal 111, the receiving device 133 will send the passenger search request signal 121 or the driver search request signal 111 to the processing device 134. Then, the processing device 134 may search for the corresponding passenger data and the passenger terminal device 110 according to the driver data in the passenger search request signal 121, or search for the corresponding driver data and the driver terminal device 120 according to the passenger data in the driver search request signal 111.

After the processing device 134 find the corresponding passenger data and the passenger terminal device 110 according to the driver data in the passenger search request signal 121, the processing device 134 generates the passenger terminal control signal 131 and the transmitting device 136 transmits the passenger terminal control signal 131 to the passenger terminal device 110. After the processing device 134 find the corresponding driver data and the driver terminal device 120 according to the passenger data in the driver search request signal 111, the processing device 134 generates the driver terminal control signal 132 and the transmitting device 136 transmits the driver terminal control signal 132 to the driver terminal device 120. Accordingly, the driver terminal device 120 and the passenger terminal device 110 may search for the corresponding passenger or taxi driver through the server terminal 130.

In one embodiment, when a driver of a dispatched taxi arrives at the agreed meeting place and wants to search for the passengers, the driver can send a passenger search request signal 121 through the driver terminal device 120 to the receiving device 133 of the server terminal 130 via the network 200. When the receiving device 133 receives the passenger search request signal 121 from the driver terminal device 120, the receiving device 133 transmits the passenger search request signal 121 to the processing device 134. The processing device 134 identifies the driver data in the passenger search request signal 121 and searches the database device 138 to find a corresponding pairing data to retrieve the passenger data in accordance with the driver data. Then, the processing device 134 controls the transmitting device 136 to send a passenger terminal control signal 131 to the passenger terminal device 110 based on the passenger data. In one embodiment, the passenger terminal control signal 131 can control the passenger terminal device 110 to vibrate or flash, or to play a recognition sound for the dispatched taxi driver to recognize. In another embodiment, if the driver terminal device 120 has a control function to control his taxi, while the driver terminal device 120 issues a passenger search request signal 121, the driver can also use the driver terminal device 120 to control the taxi flashing lights or horn to provide the passengers to recognize.

On the other hand, when the passenger arrives at the agreed meeting place and wants to search for the dispatched taxi, the passenger can send a driver search request signal 111 through the passenger terminal device 110 to the receiving device 133 of the server terminal 130 through the network 200. When the receiving device 133 receives the driver search request signal 111 from the passenger terminal device 110, the receiving device 133 sends the driver search request signal 111 to the processing device 134. The processing device 134 identifies the passenger data in the driver search request signal 111 to search for the pairing data in the database device 138 according to the passenger data to retrieve the corresponding driver data. Then, the processing device 134 controls the transmitting device 136 to send a driver terminal control signal 132 to the driver terminal device 120 based on the driver data. In one embodiment, the driver terminal device 120 can be related to the horn and the lights of the taxi. Therefore, the driver terminal control signal 132 can control the lights of the taxi to flash or the horn to generate sound for passengers to recognize. In another embodiment, while the passenger terminal device 110 sends out the driver search request signal 111, the passenger terminal device 110 can also be controlled to vibrate or flash, or to play a recognition sound for the dispatched taxi driver to recognize.

In another embodiment, after the passenger is on the taxi, the driver terminal device 120 may also send a passenger confirmation request signal 122 to confirm whether or not the passenger issues the taxi request signal or not. In another embodiment, the passenger terminal device 110 may also send a driver confirmation request signal 112 to confirm whether the taxi driver is the driver receiving the taxi request signal. In one embodiment, a physical button or icon for the confirmation request may be additionally provided on the input modules of the driver terminal device 120 and the passenger terminal device 110 for the user to touch. Accordingly, when the passenger is on the taxi, the driver can send a passenger confirmation request signal 122 to the receiving device 133 of the server terminal 130 by pressing the confirmation request button or icon on the driver terminal device 120. When the receiving device 133 receives the passenger confirmation request signal 122 sent by the driver terminal device 120, the receiving device 133 sends the passenger confirmation request signal 122 to the processing device 134. The processing device 134 will identify the driver data contained in the passenger confirmation request signal 122 and searches the database device 138 to find a corresponding pairing data to retrieve the passenger data in accordance with the driver data. Then, the processing device 134 controls the transmitting device 136 to send a passenger terminal control signal 131 to the passenger terminal device 110 based on the passenger data to control the passenger terminal device 110 to vibrate or flash, or to play a recognition sound for the dispatched taxi driver to recognize, and control the passenger terminal device 110 to display the taxi information, such as the driver's name and license plate number for the passenger to confirm. In another embodiment, the passenger terminal device 110 can also send a driver confirmation request signal 112 to the server terminal 130 to control the driver terminal device 120 to generate sound for the passenger to recognize. The implementation method is as described above and will not be repeated here.

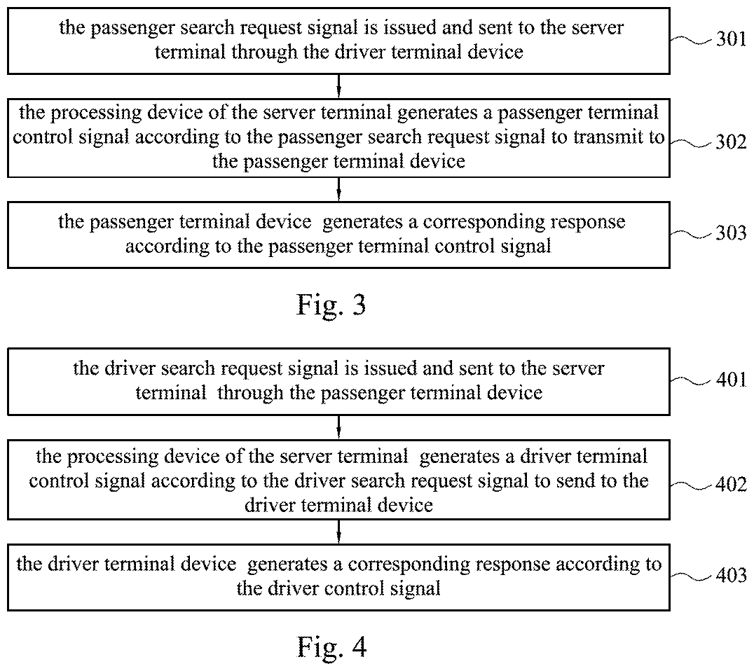

FIG. 3 is a flow chart of a taxi driver searching passengers according to an embodiment of the present disclosure. Please refer to FIGS. 1 to 3 at the same time. When the dispatched taxi driver arrives at the agreed meeting place and wants to search for passengers, a passenger search request signal 121 is issued and sent to the server terminal 130 through the driver terminal device 120 in step 301. In one embodiment, the passenger search request signal 121 will be sent to the receiving device 133 of the server terminal 130 through the network 200. After the receiving device 133 receives the passenger search request signal 121 sent by the driver terminal device 120, the receiving device 133 will send the passenger search request signal 121 to the processing device 134. In step 302, the processing device 134 of the server terminal 130 generates a passenger terminal control signal 131 according to the passenger search request signal 121 to transmit to the passenger terminal device 110. In one embodiment, the processing device 134 identifies the driver data in the passenger search request signal 121 and searches the database device 138 to find a corresponding pairing data to retrieve the passenger data in accordance with the driver data. Then, the processing device 134 controls the transmitting device 136 to send a passenger terminal control signal 131 to the passenger terminal device 110 based on the passenger data. In step 303, the passenger terminal device 110 generates a corresponding response according to the passenger terminal control signal 131. In one embodiment, the passenger terminal control signal 131 can control the passenger terminal device 110 to vibrate or flash, or to play a recognition sound for the dispatched taxi driver to recognize. In another embodiment, if the driver terminal device 120 has a control function to control his taxi, while the driver terminal device 120 issues a passenger search request signal 121, the driver can also use the driver terminal device 120 to control the taxi flashing lights or horn to provide the passengers to recognize.

FIG. 4 is a flow chart of passengers searching a taxi drive according to an embodiment of the present disclosure. Please refer to FIG. 1, FIG. 2 and FIG. 4 at the same time. When the passenger arrives at the agreed meeting place and wants to search for the dispatched taxi, a driver search request signal 111 is issued and sent to the server terminal 130 through the passenger terminal device 110 in step 401. In an embodiment, the passenger can send a driver search request signal 111 through the passenger terminal device 110 to the receiving device 133 of the server terminal 130 through the network 200. When the receiving device 133 receives the driver search request signal 111 from the passenger terminal device 110, the receiving device 133 sends the driver search request signal 111 to the processing device 134. In step 402, the processing device 134 of the server terminal 130 generates a driver terminal control signal 132 according to the driver search request signal 111 to send to the driver terminal device 120. In an embodiment, the processing device 134 identifies the passenger data in the driver search request signal 111 to search for the pairing data in the database device 138 according to the passenger data to retrieve the corresponding driver data. Then, the processing device 134 controls the transmitting device 136 to send a driver terminal control signal 132 to the driver terminal device 120 based on the driver data. In step 403, the driver terminal device 120 generates a corresponding response according to the driver control signal 132. In one embodiment, the driver terminal device 120 can be related to the horn and the lights of the taxi. Therefore, the driver terminal control signal 132 can control the lights of the taxi to flash or the horn to generate sound for passengers to recognize. In another embodiment, while the passenger terminal device 110 sends out the driver search request signal 111, the passenger terminal device 110 can also be controlled to vibrate or flash, or to play a recognition sound for the dispatched taxi driver to recognize.

Accordingly, the server terminal can control the passenger terminal device or/and the driver terminal device to vibrations, flashes or generate sound for the taxi driver or the passenger to recognize. Therefore, the driver and passengers can confirm for each other faster to complete the delivery service when they arrive at the agreed meeting place. In addition, after passenger is on the taxi, the passenger terminal device can also display the taxi information for the passenger to confirm again. Therefore, the present application can solve the problem that the driver and passengers are difficult to confirm when they arrive at the agreed meeting place because there are too many similar appearance taxis at the agreed meeting place at the same time.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A search system used for providing a passenger and a dispatched taxi driver to confirm each other at an agreed meeting place, comprising:
a server terminal;
a passenger terminal device wirelessly connected to the server terminal for sending a driver search request signal to the server terminal at the agreed meeting place; and
a driver terminal device wirelessly connected to the server terminal,
wherein when the server terminal receives the driver search request signal form the passenger terminal device, the server terminal generates a driver terminal control signal to control the driver terminal device to generate a first identification signal to the passenger to identify.

2. The search system of claim 1, wherein the server terminal further comprising:
a database device storing a plurality of pairing data, wherein each of the pairing data includes the agreed meeting place, a passenger data, and a paired driver data;
a receiving device for receiving the driver search request signal;
a processing element coupled to the receiving device for generating the driver terminal control signal according to the driver search request signal; and
a transmitting device coupled to the processing device for transmitting the driver terminal control signal,
wherein the processing device searches for a corresponding driver terminal device from the database device according to the driver search request signal to control the transmitting device to send the driver terminal control signal to the corresponding driver terminal device.

3. The search system of claim 1, wherein to control the driver terminal device to generate the first identification signal is that the driver terminal control signal controls a vehicle light of the dispatched taxi to flash or a horn of the dispatched taxi to generate sound for the passenger to recognize through the driver terminal device.

4. The search system of claim 3, wherein the vehicle light is front lights of the dispatched taxi, rear lights of the dispatched taxi, the roof lights of the dispatched taxi, or a LED light disposed in the dispatched taxi.

5. The search system of claim 3, wherein the horn plays a recognition sound for the passenger to identify.

6. The search system of claim 1, wherein the driver terminal device is a handheld device of the dispatched taxi driver or a vehicle information system on the dispatched taxi.

7. The search system of claim 1, wherein an application program sent by the server terminal is installed on the driver terminal device to communicate with the server terminal through the application program.

8. A search system used for providing a passenger and a dispatched taxi driver to confirm each other at an agreed meeting place, comprising:
a server terminal;
a passenger terminal device wirelessly connected to the server terminal; and
a driver terminal device wirelessly connected to the server terminal for sending a passenger search request signal to the server terminal at the agreed meeting place;
wherein when the server terminal receives the passenger search request signal form the driver terminal device, the server terminal generates a passenger terminal control signal to control the passenger terminal device to generate a first identification signal to the dispatched taxi driver to identify.

9. The search system of claim 8, wherein the server terminal further comprising:
a database device storing a plurality of pairing data, wherein each of the pairing data includes the agreed meeting place, a passenger data, and a paired driver data;
a receiving device for receiving the driver search request signal;
a processing element coupled to the receiving device for generating the driver terminal control signal according to the driver search request signal; and
a transmitting device coupled to the processing device for transmitting the driver terminal control signal,
wherein the processing device searches for a corresponding passenger terminal device from the database device according to the passenger search request signal to control the transmitting device to send the passenger terminal control signal to the corresponding passenger terminal device.

10. The search system of claim 8, wherein to control the passenger terminal device to generate the first identification signal is that the passenger terminal control signal controls the passenger terminal device to vibrate, to flash or to play a recognition sound for the dispatched taxi driver to recognize.

11. The search system of claim 8, wherein the passenger terminal device is a handheld device of the passenger.

12. The search system of claim 8, wherein an application program sent by the server terminal is installed on the passenger terminal device to communicate with the server terminal through the application program.

13. The search system of claim 8, wherein while the driver terminal device sending the passenger search request signal to the server terminal, the driver terminal device controls a vehicle light of the dispatched taxi to flash or a horn of the dispatched taxi to generate sound for the passenger to identify.

14. The search system of claim 13, wherein the vehicle light is front lights of the dispatched taxi, rear lights of the dispatched taxi, the roof lights of the dispatched taxi, or a LED light disposed in the dispatched taxi.

15. The search system of claim 13, wherein the horn plays a recognition sound for the passenger to identify.

16. A search method used for providing a passenger and a dispatched taxi driver to confirm each other in an agreed meeting place, comprising:
issuing, by a first terminal device, a search request signal to a server terminal at the agreed meeting place;
generating, by a processing device of the server terminal, a terminal control signal to a second terminal device according to the search request signal; and
generating, by the second terminal device, a identification signal according to the terminal control signal.

17. The search method of claim 16, wherein the first terminal device is a passenger terminal device of the passenger, the search request signal is a driver search request signal, the second terminal device is a driver terminal device of the dispatched taxi driver, and the terminal control signal is a driver terminal control signal, and
wherein the driver terminal device generates the identification signal to the passenger to identify.

18. The search method of claim 16, wherein the first terminal device is a driver terminal device of the dispatched taxi driver, the search request signal is a passenger search request signal, the second terminal device is a passenger terminal device of the passenger, and the terminal control signal is a passenger terminal control signal, and
wherein the passenger terminal device generates the identification signal to the dispatched taxi driver to identify.
